(19) United States
(12) Patent Application Publication
(10) Pub. No.: US 2023/0073586 A1
(43) Pub. Date: Mar. 9, 2023

(54) APPARATUS, SYSTEM, AND METHOD FOR ACTIVE CHANNEL SWITCHING AND SPECTRUM IDENTIFICATION IN HOSTILE RADIO FREQUENCY ENVIRONMENTS

(71) Applicant: ShadowTech Labs, Willowbrook, IL (US)

(72) Inventors: David Nahlik, Chicago, IL (US); Michael Collins, Chicago, IL (US); Dennis Collins, Park Ridge, IL (US); Jon Webb, Willowbrook, IL (US); Joseph Moore, Willowbrook, IL (US)

(21) Appl. No.: 17/859,759

(22) Filed: Jul. 7, 2022

Related U.S. Application Data
(60) Provisional application No. 63/219,313, filed on Jul. 7, 2021.
(60) Provisional application No. 63/219,798, filed on Jul. 8, 2021.

(51) Int. Cl. H04W 36/30; H04W 36/06; H04W 36/36

(52) U.S. Cl. CPC H04W 36/30; H04W 36/06; H04W 36/36

(57) ABSTRACT

An unmanned aerial vehicle (UAV) has a first radio configured to operate on one of a plurality of radio frequency (RF) channels, a processing and management application program interface (API), and a controller. A system for active radio frequency (RF) channel switching includes the UAV and a head end control unit in wireless communication with the UAV. A method of RF spectrum identification and mapping includes collecting RF data by the UAV within an area of operation, determining location data within the area of operation using a global positioning system (GPS) located on the UAV, and mapping the RF data of the area of operation using the location data.

### BACKGROUND

### 1. Field of the Disclosure

The present disclosure is generally directed to radio frequency (RF) communication, and more particularly to an apparatus, system, and method for maintaining RF communication and RF spectrum identification in hostile RF environments.

### 2. Description of Related Art

Unmanned aerial vehicles (UAVs) are used extensively by every branch of the department of defense (i.e., military branches) and law enforcement (civilian agencies) to perform various operations. UAVs are used by the department of defense and law enforcement for surveillance, reconnaissance, putting munitions on target, and the like. UAVs use a radio control system (RCS) to communicate with a head end control unit to monitor data, audio communications, and video over a radio frequency (RF). RF communication is used to perform operations such as controlling movement of the UAV, putting munitions on target, and sending and receiving data, such as video data or other data collected by the UAV. An RCS basically depends on line-of-sight for reliable operation.

Increasing use of electromagnetic signals for communication in the modern world and the modern battle space leave both environments inundated with electromagnetic signals that may cause interference with communications between UAVs and their respective head end control units. Even under optimum conditions, maintaining RF communication with a UAV is challenging and even brief losses of communication can lead to loss of control, loss of data, loss of mission, and/or catastrophic loss of asset.

### SUMMARY

Various embodiments and examples of the present disclosure are disclosed and described herein.

An embodiment 1 can include an unmanned aerial vehicle (UAV) comprising a first radio configured to operate on one of a plurality of radio frequency (RF) channels, a processing and management application program interface (API), and a controller.

An embodiment 2 can include the UAV of embodiment 1 and can further comprise a second radio configured to operate on one of the plurality of RF channels.

An embodiment 3 can include the UAV of embodiments 1 or 2, wherein at least one of the first radio and the second radio of the UAV can be in communication with a head end control unit on a current RF channel of the plurality of RF channels, and wherein at least one of the first radio and the second radio can be configured to scan alternative RF channels among the plurality of RF channels.

An embodiment 4 can include the UAV of embodiments 2 or 3, wherein the processing and management API can be configured to monitor the properties of both the active communication channel, i.e., the current RF channel, and potential alternative channels from among the plurality of RF channels.

An embodiment 5 can include the UAV of embodiments 2-4, wherein the processing and management API can be configured to automatically switch to a next best available RF channel when communication integrity of the current channel is found to be below a predetermined threshold.

An embodiment 6 can include the UAV of embodiments 2-5, wherein the processing and management API can be configured to automatically switch to a best available alternative RF channel when communication integrity of the best available alternative RF channel is greater than the communication integrity of the current RF channel.

An embodiment 7 can include the UAV of embodiments 5 or 6, wherein the processing and management API can be configured to notify the head end control unit to seamlessly transition to the best available RF channel, i.e., network.

An embodiment 8 can include the UAV of embodiments 2-7 wherein the first radio and the second radio can continually alternate as a primary communication radio in communication with a head end control unit and a scanner, scanning alternative radio channels among the plurality of RF channels.

An embodiment 9 can include the UAV of embodiments 2-8 and can further comprise a global positioning system (GPS) configured to communicate with the controller.

An embodiment 10 can include a system for active RF channel switching. The system can comprise a UAV and a head end control unit in wireless communication with the UAV.

An embodiment 11 can include the system of embodiment 10, wherein the UAV can be the UAV of any of embodiments 1-9.

An embodiment 12 can include the system of embodiments 10 or 11, wherein the head end control unit can comprise at least one radio.

An embodiment 13 can include a method of active RF channel switching. The method can comprise operating a UAV in an environment, simultaneously analyzing active RF channel(s) and alternative radio channels in the environment, determining if communication integrity of any one or more of the active RF channel(s) and/or the alternative RF channels is below a predetermined threshold, and switching to a best available or a next best available RF channel when communication integrity is threatened.

An embodiment 14 can include the method of embodiment 13, wherein communication integrity can be determined using at least one of radio signal strength, Radio Strength Signal Indicator (RSSI), signal bandwidth, and/or Signal-to-Noise Ratio (SNR).

An embodiment 15 can include a method of active RF channel switching. The method can comprise operating a UAV in an environment, simultaneously analyzing active RF channel(s) and alternative RF channels in the environment, determining if communication integrity of any one or more of the active RF channel(s) and/or the alternative RF channels is below a predetermined threshold, and switching to a best available or a next best available RF channel when the communication integrity of an alternative RF channel is greater than the communication integrity of a current RF channel.

An embodiment 16 can include the method of embodiment 15, wherein communication integrity can be determined using at least one of radio signal strength, Radio Strength Signal Indicator (RSSI), signal bandwidth, and/or Signal-to-Noise Ratio (SNR).

An embodiment 17 can include a system for radio frequency (RF) spectrum identification and mapping. The system can include a UAV configured to collect RF data of active RF spectrum frequencies within an area of operation, i.e., an environment, of the UAV. The UAV can be configured to determine global positioning system (GPS) location data of the UAV. The system can include a head end control unit in wireless communication with the UAV.

An embodiment 18 can include the system of embodiment 17, wherein the UAV can be the UAV of any of embodiments 1-9.

An embodiment 19 can include the system of embodiments 17 or 18, wherein the UAV can be configured to map the RF data of the area of operation using the location data.

An embodiment 20 can include the system of embodiments 17 or 18, wherein the head end control unit can be configured to map the RF data of the area of operation using the location data.

An embodiment 21 can include a method of RF spectrum identification and mapping. The method can comprise collecting RF data by a UAV within an area of operation, determining location data within the area of operation using a GPS located on the UAV, and mapping the RF data of the area of operation using the location data.

An embodiment 22 can include the method of embodiment 21, wherein the UAV can be the UAV of any of embodiments 1-9.

An embodiment 23 can include the method of embodiments 21 or 22 and can further comprise sending the RF data and location data to a head end control unit.

An embodiment 24 can include the method of embodiments 21-23, wherein the head end control unit can include a controller comprising a processor and memory and the head end control unit can map the RF data of the area of operation using the location data.

An embodiment 25 can include the method of embodiments 21-23, wherein the UAV maps the RF data of the area of operation using the location data.

An embodiment 26 can include the UAV, system, or method of any of embodiments 1-25, wherein the UAV can be any mobile aerial or non-aerial entity, such as, a remote-control vehicle, a warfighter with a wireless communication unit, a drone, or any other mobile device, etc. or a stationary wireless communication device, such as a wireless communication device dropped or deployed by a mobile entity.

An embodiment 27 can include the UAV, system, or method of any of embodiments 1-26, wherein the UAV can be further configured to communicate with one or more nodes of a wireless network. The one or more nodes can be, or can be carried by, any mobile entity such as a UAV, a remote-control vehicle, a drone, a warfighter with a wireless communication unit, or any other mobile device etc., or a wireless communication device dropped or deployed by a mobile entity.

Thus, in the embodiments of the present disclosure, the vehicle, system, and method may be or employ a ground-based, unmanned, non-aerial vehicle or an airborne unmanned vehicle, i.e., a UAV.

### BRIEF DESCRIPTION OF THE DRAWINGS

Objects, features, and advantages of the present disclosure should become more apparent upon reading the following description in conjunction with the drawing figures, in which:

FIG. 1 shows an unmanned aerial vehicle (UAV) for active radio frequency (RF) channel switching and radio frequency (RF) spectrum identification and mapping according to the teachings of the present disclosure.

FIG. 2 shows a system for active radio frequency (RF) channel switching according to the teachings of the present disclosure.

FIG. 3 shows. a flow chart for a method of active radio frequency (RF) channel switching according to the teachings of the present disclosure.

FIG. 4 shows a system for radio frequency (RF) spectrum identification and mapping according to the teachings of the present disclosure.

FIG. 5 shows a flow chart for a method of radio frequency (RF) spectrum identification and mapping according to the teachings of the present disclosure.

FIG. 6 shows an example of a mobile entity, including substantially similar components as the UAV of FIG. 1 and configured for use in the systems and methods of FIGS. 2-5 according to the teachings of the present disclosure.

FIG. 7 shows another example of a mobile entity, including substantially similar components as the UAV of FIG. 1 and configured for use in the systems and methods of FIGS. 2-5 according to the teachings of the present disclosure.

FIG. 8 shows an example network including a remote-controlled vehicle configured to drop communication pucks, i.e., nodes, and including a plurality of the stationary nodes that may be deployed by the remote-controlled vehicle according to the teachings of the present disclosure.

DETAILED DESCRIPTION OF THE DISCLOSURE

The disclosed apparatus, systems, and methods solve or improve upon the above noted and/or other problems or disadvantages with prior known systems and solutions.

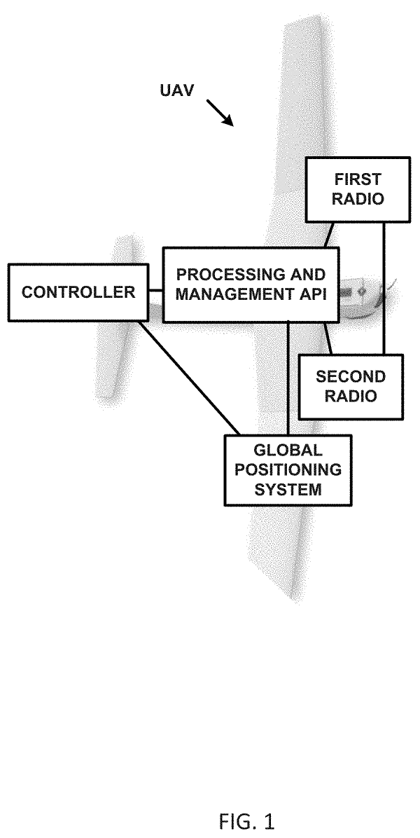

Turning now to the drawings, FIG. 1 shows an unmanned aerial vehicle (UAV) for active radio frequency (RF) channel switching and radio frequency (RF) spectrum identification and mapping according to the teachings of the present disclosure. In one example, an apparatus, a system that uses the apparatus, and a method that utilizes the system and apparatus for active RF channel switching are disclosed and described herein according to the teachings of the present disclosure. In another example, an apparatus, a system that uses the apparatus, and a method that utilizes the system and apparatus for RF spectrum identification and mapping are described herein according to the teachings of the present disclosure. In one example, the apparatus of FIG. 1 is configured to and may both employ the system and perform the method for active RF channel switching and employ the system and perform the method for RF spectrum identification and mapping simultaneously.

The apparatus of FIG. 1 is generally configured to maintain RF communication with a head end control unit in hostile radio frequency environments, such as for example, environments with a lot of, i.e., substantial, electromagnetic interference. The apparatus of FIG. 1 is also generally configured to perform RF mapping using spectrum identification and global positioning system (GPS) location. The apparatus of FIG. 1 provides a UAV having improved RF communication strength and resiliency and a UAV capable of geo-mapping all line-of-sight RF signals operating in an area.

FIG. 1 shows a generic example of the UAV, which is remotely operated and radio-controlled from a head end unit. The UAV provides the tactical warfighter or operator with intelligent aerial reconnaissance. The UAV can be equipped to provide high definition video, infra-red (IR) illumination, motion sensor analytics, two-way data communications, and two-way communications for voice/audio/sound. Thus, the UAV can provide video images, audio data, various sensor data, and the like from the location of the UAV. The UAV can run on a battery for continuous operation. The battery type, size, and life can be varied, depending on the needs of a given operation or system purpose. The life or run time duration of the battery can vary depending on the battery characteristics. In one example, the battery can provide at least two (2) hour of continuous operation for the UAV and the on-board electronic equipment and functions. Alternatively, the UAV can run on gasoline or other types of fossil or other fuel for continuous operation.

The UAV may include a motor or engine, which receive power or energy from the battery or fuel and may include one or more propellers. The UAV may further include wheels and wings to facilitate take-off, flight and landing. The size, shape, and configuration of the UAV can vary considerably within the scope and spirit of the present disclosure. The UAV body can be lightweight, if desired. The body or shell of the UAV may be formed of any suitable material, but in one example can be configured to resist damage from projectiles, shrapnel, explosives, and the like. The UAV can also include one or more on-board processors and/or printed circuit boards (PCBs) to provide and control the various motors or engines, electronic devices, and other capabilities of the UAV. The UAV can also include an internal antenna or a deployed or extended antenna to enhance signal strength and reception.

In one example, as shown in FIG. 1, the UAV includes a first radio, a second radio, a GPS, and a controller in communication with a processing and management application program interface (API). In another example, the UAV includes a radio, a controller, and a GPS in communication with a processing and management API. In yet another example, the UAV includes a first radio, a second radio, and a controller in communication with a processing and management API.

In one example, the first radio and the second radio are both configured to communicate with a head end control unit using RF communication channels. Additionally, both the first radio and second radio may be configured to scan additional radio frequency channels, determining the communication integrity of the alternative radio frequency channels. The communication integrity of the alternative radio channels may be determined using one or more of the radio signal strength, Radio Signal Strength Indicator (RSSI), signal bandwidth, or the Signal-to-Noise Ratio (SNR). The first radio and second radio may further be configured to determine RF data corresponding to the frequency and strength of received RF interference. In some embodiments, the first radio and second radio may continually alternate as a primary communication radio, in communication with the head end, and a scanner, determining the communication integrity of alternative RF channels.

In one example, the GPS is configured to determine location data, corresponding to the location of the UAV. The GPS may include a receiver and a correlation chip to obtain GPS or Global Navigation Satellite System (GNSS) signal.

In one example, the controller is in communication with the processing and management API. In another example, the controller is in communication with the first radio, second radio, GPS, and processing and management API. The controller may include a processor and memory. In one example, the controller may be configured to pair RF data with the location data collected at the location from which the RF data was collected. In one example, the controller is configured to map the RF data using the location data.

In one example, the processing and management API monitors the communication integrity of the current RF channel and the communication integrity of the alternative communication channels using one or more of the radio signal strength, Radio Signal Strength Indicator (RSSI), signal bandwidth, or the Signal-to-Noise Ratio (SNR) received from the first and second radios. The processing and management API may further identify the RF channel having the best communication integrity and a next best alternative or available RF channel. The processing unit may further determine whether the communication integrity of the current RF channel is above a threshold. If the communication integrity of the current RF channel is below a threshold, the processing and management API may switch to the next best available RF channel. In one example, the processing and management API may be configured to determine the frequencies that are free of RF interference using RF data collected by the first or second radio.

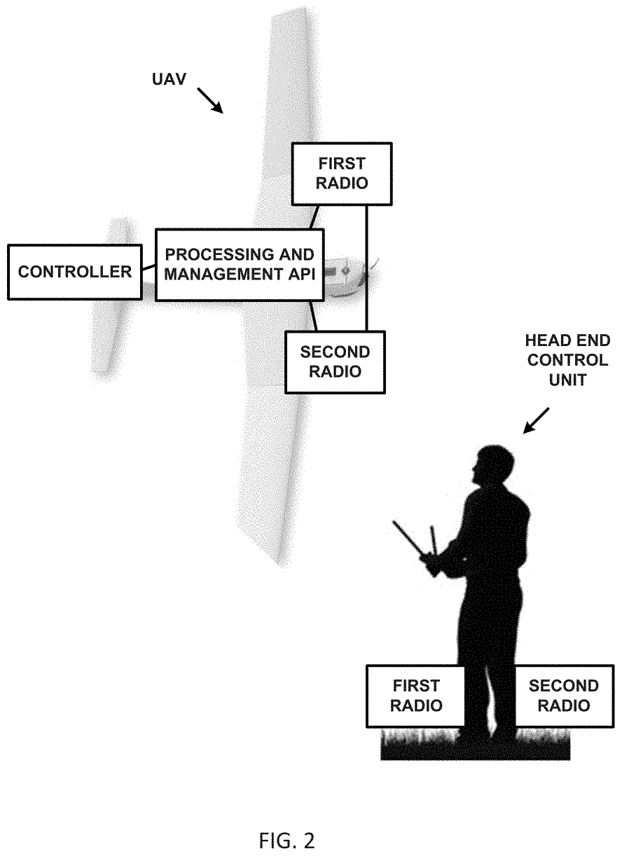

Referring to FIG. 2, a system for active RF channel switching according to the teachings of the present disclosure is shown. In one example, as shown in FIG. 2, the system for active RF channel switching includes a UAV and a head end control unit. The UAV according to the system of FIG. 2 may be the same UAV as described above with respect to FIG. 1 or may be a different type of UAV.

The head end control unit includes at least one radio in communication with the UAV. The UAV is controlled using RF signals sent wireles sly from the head end control unit to the UAV. In one example, the head end control unit further includes a controller comprising a processor and memory. The UAV may be operated by the controller and processor, and/or by an operator located at the head end control unit.

In the system of FIG. 2, a first radio and second radio located on the UAV continually alternate as a primary communications radio and a scanner radio. The primary communications radio communicates with the head end control unit using a current RF channel for the operation of the UAV and transmission of data between the UAV and head end unit. The primary communications radio may further determine the communication integrity of current RF channel. The communication integrity may be determined using at least one of radio signal strength, Radio Strength Signal Indicator (RSSI), signal bandwidth, and/or Signal-to-Noise Ratio (SNR). The scanner radio scans alternative RF channels and determines the communication integrity of the alternative RF channels. The first radio and second radio may be in communication with the processing and management API. The first radio and second radio may be in communication with the controller.

The processing and management API receives the communication integrity information of the current RF channel from the first or second radio. The processing and management API receives information regarding the communication integrity of alternative RF channels from the first or second radio. The processing and management API may determine a best alternative RF channel based on the communication integrity of the current RF channel and alternative RF channels. The processing and management API may determine if the communication integrity of the current RF channel is less than the communication integrity of an alternative RF channel. The processing and management API may issue a command to switch to communicate with the head end control unit using one of the alternative RF channels when the communication integrity of the one alternative RF channel is greater than the communication integrity of the current RF channel. The processing and management API may determine if the communication integrity of the current RF channel is less than a threshold. If the communication integrity of the current RF channel is less than the threshold, the processing and management API may issue a command switch to communicate with the head end using the alternative RF channel with the best determined communication integrity. The processing and management API may seamlessly and in real time notify the head end unit of transition to an alternative RF channel. The processing and management API may be further configured to confirm that the new network pathway (i.e., the new RF channel) is established. The processing and management API may resume scanning alternative RF channels after the new network pathway is established.

The system for active RF channel switching according to the teachings of the present disclosure improves wireless communication between the UAV and head end control unit. This reduces the risk of a loss of communication even in the most hostile RF environments.

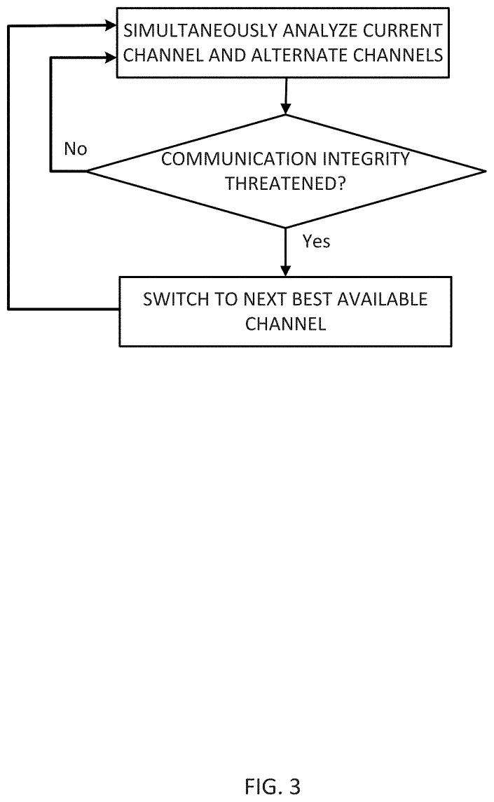

Referring to FIG. 3, a flow chart for a method of active RF channel switching according to the teachings of the present disclosure is shown. In one example, the method of active RF channel switching includes a first step of simultaneously analyzing the communication integrity of the current RF channel and available or detectable alternative RF channels. In this step, the processing and management API receives the communication integrity of the current RF communication channel and alternative RF channels from the first and second radios. In this step, the processing and management API may further determine a next best available RF channel from the alternative RF channels. In a second step, the processing and communication API determines if the communication integrity between the UAV and head end unit is threatened. The communication integrity may be threatened if the communication integrity of the current communication RF channel falls below a threshold, or if the communication integrity of an alternative RF channel is greater than the communication integrity of the current communication RF channel. In the second step of the method, if the communication integrity is not threatened, the processing and management API repeats step one. If the communication integrity is threatened, in a third step of the method, the current communication RF channel is switched to the next best available RF channel.

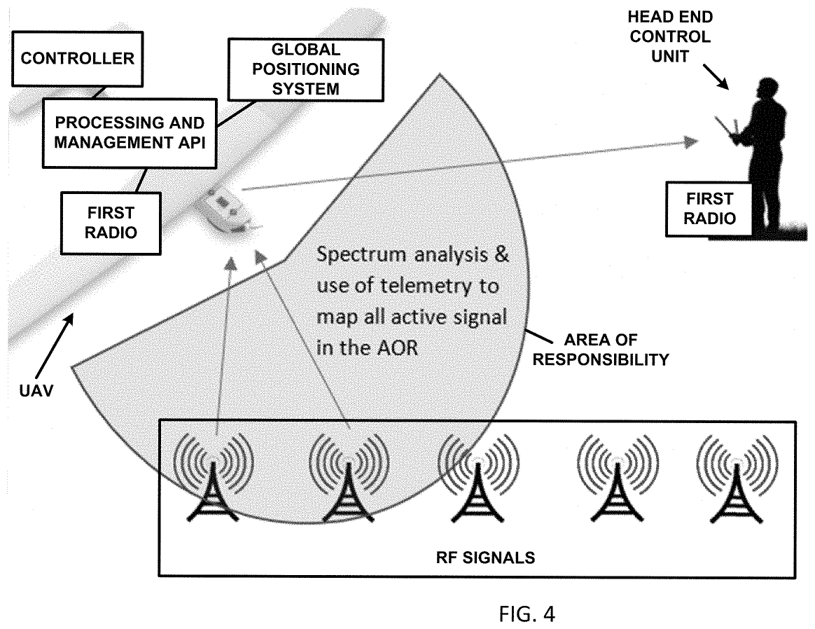

Referring to FIG. 4, a system for RF spectrum identification and mapping according to the teachings of the present disclosure is shown. In one example, as shown in FIG. 4, the system for spectrum identification and mapping includes a UAV, a head end control unit, and one or more RF signals. The UAV according to the system of FIG. 4 may be the same UAV as described above with respect to FIG. 1.

The head end control unit includes at least one radio in communication with the UAV. The UAV is controlled using RF signals sent wirelessly from the head end control unit to the UAV. In one example, the head end control unit further includes a controller comprising a processor and memory. The UAV may be operated by the controller and processor, or by an operator located at the head end control unit.

In one example, a first radio, located in the UAV may communicate with the at least one radio of the head end control unit. In one example, the first radio located in the UAV may further be configured to collect RF data of active RF spectrum signal frequencies within an area of operation of the UAV, such as for example, the line of sight of the UAV or within a region in which the first radio can detect the active RF spectrum frequencies. Alternatively, the UAV may include a second radio, configured to collect RF data of active RF spectrum signal frequencies within an area of operation of the UAV. The RF data may include the frequency and strength of received RF interference.

In one example, the first radio may send the RF data and the corresponding location data to the head end control unit. The controller located in the head end control unit may then map the RF data using the location data, producing a signal map of the area of operation of the UAV. In another example, the controller located on the UAV may map the RF data of the area of operation using the location data. In one example, the first radio may send the mapped RF data to the head end control unit.

The system for RF spectrum identification and mapping according to the teachings of the present disclosure allows for mapping of active radio frequencies and the strength of received RF interference within an area of operation of a UAV. The RF data may be mapped in real time and exploits the elevated vantage point of the UAV. The mapped RF data may further be used to avoid RF frequencies with high levels of interference, identify hostile actors, and/or target known threats.

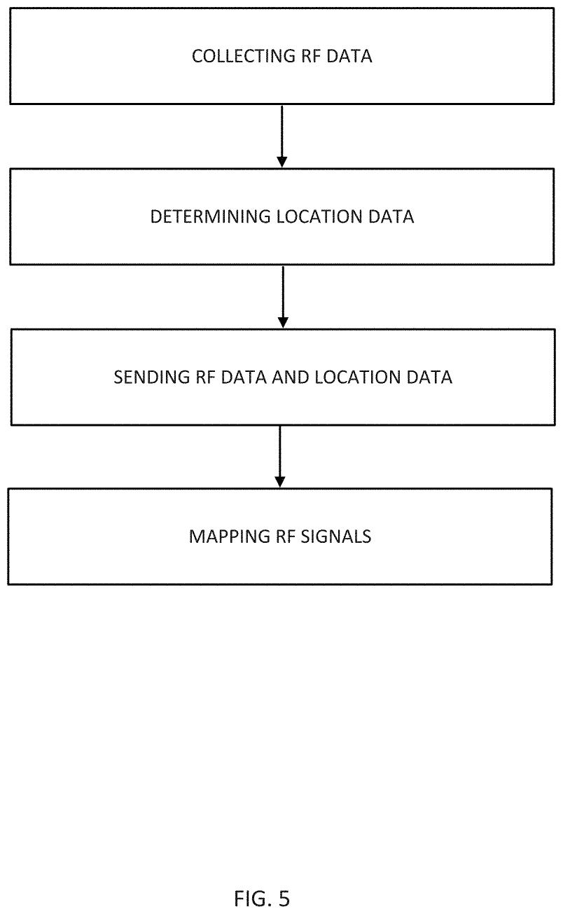

Referring to FIG. 5, a flow chart for a method of RF spectrum identification and mapping according to the present disclosure is shown.

In one example, the method of RF spectrum identification and mapping includes a first step of collecting RF data of active RF spectrum signal frequencies within an area of operation of a UAV. The RF data may include the frequency and strength of received RF interference. In some examples, the RF data is collected by a first radio located on the UAV. In other examples, the RF data is collected by a second radio located on the UAV.

In one example, the method of RF spectrum identification and mapping includes a second step of determining location data corresponding to the location of the UAV. The location data is determined using the GPS located on the UAV. The method of RF spectrum identification and mapping includes a third step of sending RF data and the location data to a head end control unit via a first radio or a second radio located on the UAV. The head end control unit may include one or more radios configured to receive the RF data and location data from the UAV.

In one example, the method of RF spectrum identification and mapping includes a fourth step of mapping the RF data using the location data. The head end control unit may include a controller including a processor and memory configured to map the RF data using the location data. In another example, a controller located on the UAV may map the RF data using the location data. In this example, a first radio or a second radio, located on the UAV may send the mapped RF data to a head end control unit.

In some examples, the UAV as described above with respect to the apparatuses, systems, and methods may be any mobile, stationary, or semi-stationary entity having substantially similar components as are described with reference to the UAV. Such mobile, stationary, or semi-stationary devices include any battlefield communication devices including radios of the same type used by the UAV. Examples of such mobile entities include a remote-control vehicle, a warfighter with one or more wireless communication units, any other mobile or stationary device, or the like. Examples of stationary wireless communication devices include a wireless communication device located at a base, a redundant network relay, or the like. An example of a semi-stationary entity is a wireless communication device dropped or deployed in the field by a mobile device, or the like.

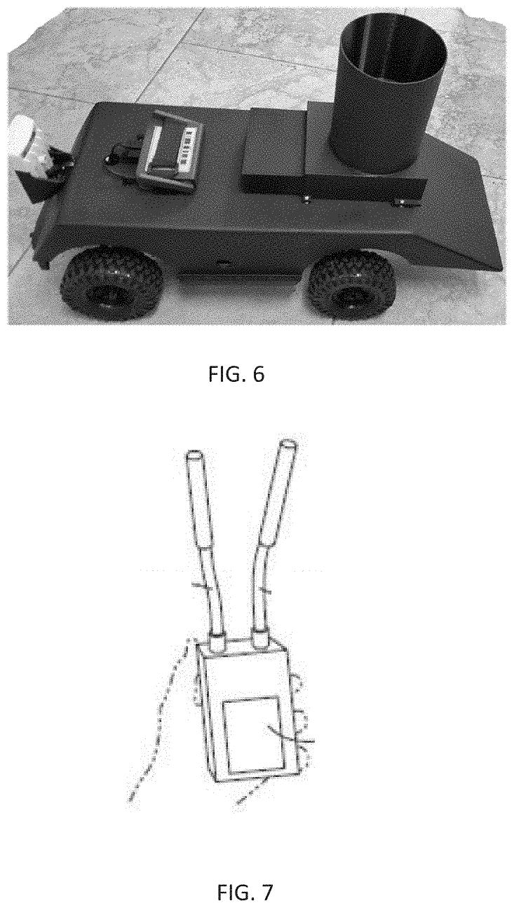

FIG. 6 shows an example of a mobile entity which may include substantially similar components to the UAV as described above. The mobile entity of FIG. 6 is a remote-controlled vehicle capable of deploying stationary wireless communication devices or pucks in the field to establish and maintain a wireless communication network within the field. In other examples, the remote control vehicle may carry one or more wireless communication devices and be moved within the field creating a dynamic wireless network node in the field. FIG. 7 shows another example of a wireless communication device which may include substantially similar components to the UAV as described above. One or more of the wireless communication devices of FIG. 7 may be carried by a warfighter in the field.

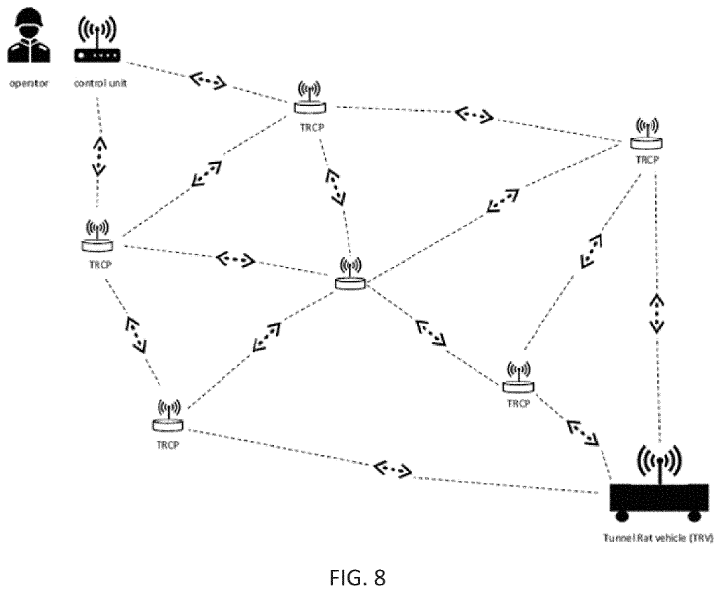

In some examples, the UAV or other mobile, stationary or semi-stationary entities may be configured to communicate with one or more wireless communication nodes in the field, i.e., the area of operation of operation environment, in addition to the head end control unit. The wireless communication nodes may be additional UAVs, remote-control vehicles, warfighters with wireless communication units, any other mobile devices, stationary wireless communication devices located at a base, or stationary wireless devices dropped or deployed by a mobile entity. The wireless communication nodes may be any wireless communication device having radios as the same type as the UAV or other mobile, stationary, or semi-stationary entity and configured to communicate with the UAV or other mobile, stationary, or semi-stationary entity. When the UAV or other mobile, stationary or semi-stationary entity communicates with one or more wireless communication nodes in the field, in addition to the head end control unit, the processing and management API may be further configured to communicate the next best available RF channel to all nodes in the network. The processing and management API may additionally coordinate the RF channel switch to the new channel on the UAV or other mobile, stationary, or semi-stationary entity, the head end control unit, and all nodes in the network. The processing and management unit may additionally confirm that the new network pathway is up and running on the UAV, nodes, and head end control unit. FIG. 8 shows an example network including a remote-controlled vehicle configured to drop communication pucks, i.e., nodes, and including a plurality of the stationary nodes that may be deployed by the remote-controlled vehicle.

Although certain apparatuses, systems, and methods have been described herein in accordance with the teachings of the present disclosure, the scope of coverage of this patent is not limited thereto. On the contrary, this patent covers all embodiments of the teachings of the disclosure that fairly fall within the scope of permissible equivalents.

1. An unmanned aerial vehicle (UAV), comprising:
a first radio configured to operate on one of a plurality of radio frequency (RF) channels;
a processing and management application program interface (API); and
a controller.

2. The UAV of claim 1, further comprising:
a second radio configured to operate on one of the plurality of RF channels.

3. The UAV of claim 1, wherein at least one of the first radio and the second radio of the UAV is in communication with a head end control unit on a current RF channel of the plurality of RF channels, and wherein at least one of the first radio and the second radio is scanning alternative RF channels among the plurality of RF channels.

4. The UAV of claim 2, wherein the processing and management API is configured to monitor the properties of both the active communication channel, i.e., the current RF channel, and potential alternative channels from among the plurality of RF channels.

5. The UAV of claim 2, wherein the processing and management API is configured to automatically switch to a next best available RF channel when communication integrity of the current channel is found to be below a predetermined threshold.

6. The UAV of claim 2, wherein the processing and management API is configured to automatically switch to a best available alternative RF channel when communication integrity of the best available alternative RF channel is greater than the communication integrity of the current RF channel.

7. The UAV of claim 5, wherein the processing and management API is configured to notify the head end control unit to seamlessly transition to the best available RF channel, i.e., network.

8. The UAV of claim 2, wherein the first radio and the second radio continually alternate as a primary communication radio in communication with a head end control unit and a scanner, scanning alternative radio channels among the plurality of RF channels.

9. The UAV of claim 2, further comprising:
a global positioning system (GPS) configured to communicate with the controller.

10. A system for active RF channel switching, the system comprising:
a UAV according to claim 1; and
a head end control unit in wireless communication with the UAV.

11. (canceled)

12. The system of claim 10, wherein the head end control unit comprises at least one radio.

13. A method of active radio frequency (RF) channel switching, the method comprising:
operating an unmanned aerial vehicle (UAV) in an environment;
simultaneously analyzing active RF channel(s) and alternative radio channels in the environment;
determining if communication integrity of any one or more of the active RF channel(s) and/or the alternative RF channels is below a predetermined threshold; and
switching to a best available or a next best available RF channel when communication integrity is threatened.

14. The method of claim 13, wherein communication integrity is determined using at least one of radio signal strength, Radio Strength Signal Indicator (RSSI), signal bandwidth, and/or Signal-to-Noise Ratio (SNR).

15. The method of claim 13, further comprising:
switching to a best available or a next best available RF channel when the communication integrity of an alternative RF channel is greater than the communication integrity of a current RF channel.

16. The method of claim 15, wherein communication integrity is determined using at least one of radio signal strength, Radio Strength Signal Indicator (RSSI), signal bandwidth, and/or Signal-to-Noise Ratio (SNR).

17. A system for RF spectrum identification and mapping, the system comprising:
a UAV according to claim 1 and configured to collect RF data of active RF spectrum frequencies within an area of operation, i.e., an environment, of the UAV, the UAV being further configured to determine global positioning system (GPS) location data of the UAV; and
a head end control unit in wireless communication with the UAV.

18. (canceled)

19. The system of claim 17, wherein the UAV or the head end control unit is configured to map the RF data of the area of operation using the location data.

20. (canceled)

21. The method of claim 13, further comprising:
collecting RF data by the UAV within an area of operation;
determining location data within the area of operation using a global positioning system (GPS) located on the UAV; and
mapping the RF data of the area of operation using the location data.

22. (canceled)

23. The method of claim 21, further comprising:
sending the RF data and location data to a head end control unit.

24. The method of claim 21, wherein the head end control unit includes a controller comprising a processor and memory and the head end control unit or the UAV maps the RF data of the area of operation using the location data.

25. (canceled)
